(19) United States
(12) Patent Application Publication
(10) Pub. No.: US 2026/0023664 A1
(43) Pub. Date: Jan. 22, 2026

(54) Adaptive Spare Block Cycling With Multi-Die Blocks

(71) Applicant: Sandisk Technologies, Inc., Milpitas, CA (US)

(72) Inventors: Michael IONIN, Rehovot (IL); Alexander BAZARSKY, Holon (IL); Itay BUSNACH, Raanana (IL)

(73) Assignee: Sandisk Technologies, Inc., Milpitas, CA (US)

(21) Appl. No.: 18/779,891

(22) Filed: Jul. 22, 2024

(51) Int. Cl. G06F 11/20

(52) U.S. Cl. CPC G06F 11/2094; G06F 2201/805

(57) ABSTRACT

An imbalance of wear of blocks in a flash die will negatively affect the memory health of a storage device, including decreased device performance. Specifically, when spare blocks of the device remain at zero program/erase (P/E) cycles while, during typical device operation, regular blocks in the flash die are cycled. Cycling spare blocks and regular blocks of the device at the same rate reduces the adverse effects on device memory health. By calculating the rate of spare block updates (i.e., frequency of flash-fill operations and subsequent erasure of the spare blocks) and executing interleaved periodic segmented flash fill operations and erase operations on the spare blocks during the corresponding operations to the regular blocks, the wear of blocks is “leveled” and an imbalance is avoided. In some embodiments, the cycling of the spare blocks is segmented even further by braking the cycling operations into micro-segments.

### BACKGROUND OF THE DISCLOSURE

### Field of the Disclosure

Embodiments of the present disclosure generally relate to a data storage device with adaptive spare block cycling for wear leveling between flash blocks.

### Description of the Related Art

Non-volatile storage devices have enabled increased portability of data and software applications. During the operation of a storage device, data may be programmed to the storage device, read from the storage device, and erased from the storage device. In high-end storage devices, data is usually divided in a lateral manner between all operating dies/channels to maximize throughput. Then, the corresponding block on each of the dies/channels is called a jumbo-block. A jumbo-block may contain blocks from multiple dies, up to 128 in current storage devices and even more in the future.

In each flash die, there is a set number of blocks, according to its capacity, with a spare set of blocks in order to allow for bad block replacement. As a storage device is used, the storage device may be subject to physical wear that increases data errors at the storage device. The storage device may also experience some physical defect that is either manifested during production or grown during the operation of the storage device. For example, multiple program/erase (P/E) cycles may cause physical wear to storage elements of a storage device, resulting in more errors during reading of data from the storage elements of the storage device. In some cases, physical wear can cause a number of errors of data to exceed an error correction capability associated with an encoding technique used to encode the data. Further, there is a certain maximum number of bad blocks that the device can endure before it impacts the exported capacity.

To reduce or avoid data loss, storage devices may use wear leveling to distribute wear among regions of the memory. Previously, there was no requirement to cycle the spare blocks that were used to replace the grown bad blocks. Though, wear leveling algorithms may be used in flash storage to balance the usage of the different blocks, certain wear leveling schemes may add too much overhead to the management, which in turn affects device performance.

Accordingly, there is a need in the art for an improved data storage device with adaptive spare block cycling for wear leveling between blocks having minimal overhead and negligible impact on the performance.

### SUMMARY OF THE DISCLOSURE

An imbalance of wear of blocks in a flash die will negatively affect the memory health of a storage device, including decreased device performance. Specifically, when spare blocks of the device remain at zero program/erase (P/E) cycles while, during typical device operation, regular blocks in the flash die are cycled. Cycling spare blocks and regular blocks of the device at the same rate reduces the adverse effects on device memory health. By calculating the rate of spare block updates (i.e., frequency of flash-fill operations and subsequent erasure of the spare blocks) and executing interleaved periodic segmented flash fill operations and erase operations on the spare blocks during the corresponding operations to the regular blocks, the wear of blocks is “leveled” and an imbalance is avoided. In some embodiments, the cycling of the spare blocks is segmented even further by breaking the cycling operations into micro-segments.

In one embodiment, a data storage device includes a memory device; and a controller coupled to the memory device, wherein the controller is configured to: engage in a write workload on a first block of a plurality of blocks; execute an erase operation on a segment of a second block of a plurality of blocks; and execute a write operation on a segment of the first block, wherein the second block is the next block to engage in a write workload; determine whether a first parameter has elapsed a threshold; and execute an erase operation on a segment of a first spare block of a plurality of spare blocks if the first parameter has elapsed the threshold.

In another embodiment, a data storage device includes a memory device; and a controller coupled to the memory device, wherein the controller is configured to split each block of a plurality of blocks on a die into a plurality of segments, wherein the plurality of blocks comprise at least one regular block and at least one spare block; execute an update operation on a segment of the plurality of segments of the at least one regular block; and execute an update operation on a segment of the plurality of segments of the at least one spare block.

In yet another embodiment, a data storage device includes means to store data; and a controller coupled to the means to store data, wherein the controller is configured to engage in a write workload on a plurality of blocks; record a number of program/erase (P/E) cycles for each block of the plurality of blocks; determine a block with the least number of P/E cycles; and write to the block with the least number of P/E cycles.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is flowchart illustration of a spare block cycling operation, according to some embodiments.

FIG. 3 is a flowchart illustration of a segmented spare block cycling operation, according to some embodiments.

FIG. 4 is a flowchart illustration of a micro-segmented spare block cycling operation, according to some embodiments.

FIG. 5 is a flowchart illustration of a cycling operation, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

An imbalance of wear of blocks in a flash die will negatively affect the memory health of a storage device, including decreased device performance. Specifically, when spare blocks of the device remain at zero program/erase (P/E) cycles while, during typical device operation, regular blocks in the flash die are cycled. Cycling spare blocks and regular blocks of the device at the same rate reduces the adverse effects on device memory health. By calculating the rate of spare block updates (i.e., frequency of flash-fill operations and subsequent erasure of the spare blocks) and executing interleaved periodic segmented flash fill operations and erase operations on the spare blocks during the corresponding operations to the regular blocks, the wear of blocks is “leveled” and an imbalance is avoided. In some embodiments, the cycling of the spare blocks is segmented even further by breaking the cycling operations into micro-segments.

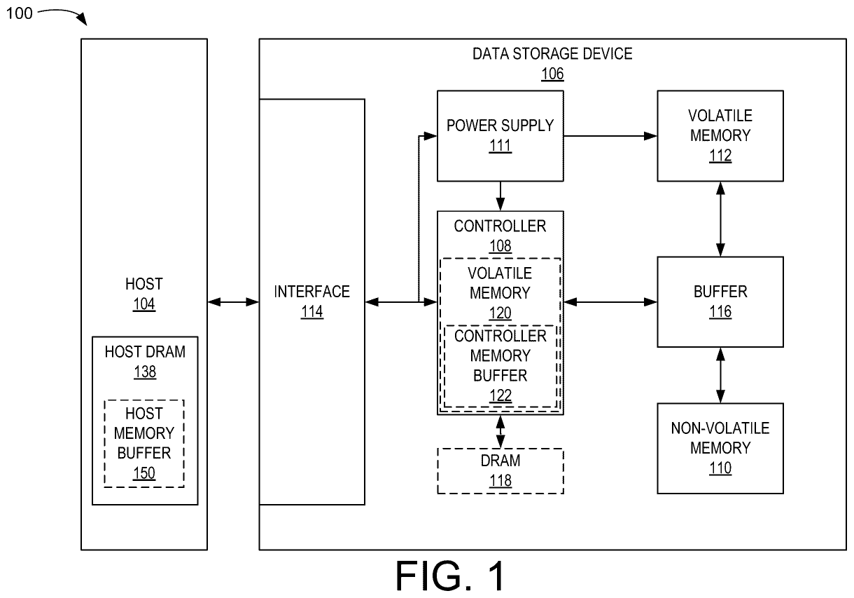

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVMe Flash memory devices may include NAND or NOR-based flash memory devices and may store data based on a charge contained in a floating gate of a transistor for each flash memory cell. In NVMe flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVMe cells. Rows of NVMe cells may be electrically connected using a word line to define a page of a plurality of pages. Respective cells in each of the plurality of pages may be electrically connected to respective bit lines. Furthermore, NVMe flash memory devices may be 2D or 3D devices and may be single level cell (SLC), multi-level cell (MLC), triple level cell (TLC), or quad level cell (QLC). The controller 108 may write data to and read data from NVMe flash memory devices at the page level and erase data from NVMe flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

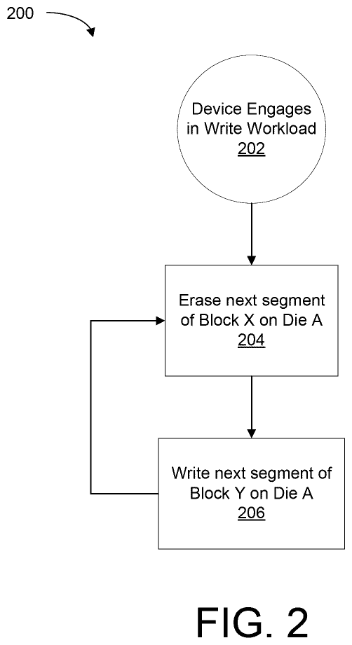

FIG. 2 is flowchart illustration of a segmented block cycling operation 200, according to some embodiments. The storage media in each flash die is divided into blocks, which are the smallest units that can be deleted. In high-end storage devices, data is divided in a lateral manner between all operating dies/channels in order to maximize throughput. Then, the corresponding block on each of the dies/channels is called a jumbo-block. A jumbo block may contain blocks from multiple dies, up to 128 in current devices and more in the future. In each flash die, there is a number of blocks, according to its capacity, with a spare set of blocks in order to allow for bad block replacement.

Bad blocks may have a physical defect that is either manifested during production or grown during the operation of the storage device. Additionally, there is a certain maximum number of bad blocks that the device can endure before exported capacity is impacted. Accordingly, as data is written and erased to and from the device, flash blocks are worn and their features change. Previously, spare blocks would remain at zero P/E cycles, while regular blocks would be cycled by normal device write/erase operation processes. However, when a spare block would replace a regular block with a growth defect, the spare block would not be balanced with the regular blocks in the jumbo-block. This imbalance has an adverse effect on memory health. Thus, in order to maintain performance and efficiency of the device, a system may have wear leveling operations to correct the imbalance between the used flash blocks (e.g., the regular blocks) and the unused flash blocks (e.g., the spare blocks).

Implementation of a segmented block cycling operation in a storage device, such as segmented block cycling operation 200, effectively cycles the spare blocks in each die with minimal impact to performance and overhead. As blocks continuously get larger, the time needed to erase the block in one atomic operation also increases. In one embodiment, the storage device splits the erase operation into several atomic operations with a shorter pulse—e.g., a segment. In some embodiments, the erase operation is split into 6 distinct pulses (e.g., segments) to fully erase a block in a die. It is to be noted that the number of splits detailed in the segmented block cycling operation 200 is for exemplary purposes and is not intended to be limiting.

A controller of the storage device (e.g., controller 108 of FIG. 1) utilizes the splits to the advantage of the device by interleaving erase operations with write operations to another block in the same die. The interleaving of erase operations with write operations limits the impact to performance and overhead and is particularly beneficial during write heavy workloads because there is no “bubble” in the write performance of the die. In eSSD systems, these performance “bubbles”—periods with reduced performance due to simultaneous background operations (e.g., block erasure)—are particularly undesirable. In some embodiments, these performance “bubbles” may be detected by customer qualification tests, where input/output operations per second (IOPS) are measured in small windows of about 100 milliseconds (ms). Single erase operations can take up to 10 ms, which may cause all the dies to be idle for 10% (i.e., 10 ms/100 ms) of the window duration—causing significant variation from the average IOPS.

To recycle spare blocks, a storage device needs to fill all the wordlines of a block before erasing it. This can be achieved by using a segmented flash-fill command which writes several wordlines at a time. In some embodiments, a flash-fill operation is used by the controller before erasing a block in case it was preemptively closed, since blocks are fully written before being erased. A flash-fill operation is a NAND command that writes a random pattern to flash wordlines. In some embodiments, the spare blocks may be erased along with the regular blocks. In certain embodiments, the segmented block cycling operation is a segmented erase operation. In a segmented erase operation, during one of the segments the erasure of a spare block is conducted. In certain embodiments, during a write operation to regular blocks a segmented flash-fill operation of a spare block is also executed.

Segmented block cycling operation 200 starts at operation 202, where the storage device engages in a write workload. At operation 204, the controller executes an erase operation on a next segment of a next block (e.g., Block X in FIG. 2) on a die (e.g., Die A). At operation 206, the controller executes a write operation (e.g., a flash-fill operation) on a next segment of a current block (e.g. Block Y in FIG. 2) on the same die (i.e., Die A). Each erase operation erases the next distinct pulse/segment of the next block, which is interleaved with each writing operation writing to the next distinct pulse/segment of the current block.

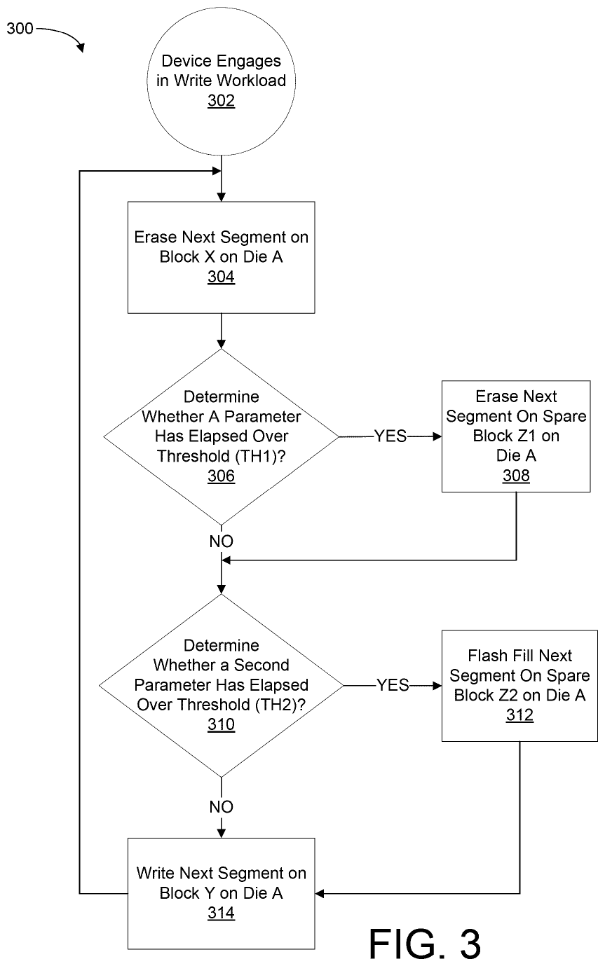

FIG. 3 is a flowchart illustration of a segmented spare block cycling operation 300, according to some embodiments. In some embodiments, segmented spare block cycling operation 300 is an implementation of segmented spare block cycling operation 200 of FIG. 2. In segmented spare block cycling operation 300, the spare block segmented write operation (e.g., a flash-fill operation), which occurs during the write operation of regular blocks, occurs periodically, depending on the number of spare blocks in the die. All spare blocks are cycled at the same rate as the regular blocks, and the rate of spare block updates (e.g., erase/write operations) is calculated by the controller (e.g., controller 108 of FIG. 1) according to the number of spare blocks in the die.

For example, if there are 100 regular blocks and 5 spare blocks, the controller will initiate a total of 5 erase segments (ES) of spare blocks for every 100 ES of regular blocks. As a result, the ES of spare blocks will occur at the same rate as the ES of regular blocks, such that an ES of the spare blocks occurs about once every 20 regular erase/write segments (i.e., 100/5=20 regular erase/write segments). That is, in order to cycle the spare blocks at the same rate as the regular blocks, spare blocks will be periodically erased along with the regular block. Accordingly, the controller executes one segmented erase operation on a spare block of the 5 spare blocks about every 20 segmented erase/write operations on a regular block of the 100 regular blocks, since there are 100 regular blocks. As a result, by the time each of the 100 regular blocks are updated once, via the segmented erase/write operations, each of the spare blocks are also updated once, and the cycling rate of the spare blocks and regular blocks are equal. It is to be noted that the number of blocks and segments detailed in the segmented block cycling operation 300 is for exemplary purposes and is not intended to be limiting.

Similarly, where there are 100 regular blocks and 5 spare blocks, at about every 20 segmented wordline write operation (e.g., segmented flash-fill operations) on regular blocks the controller executes a segmented flash-fill operations on a spare block. In some embodiments, there is a margin (e.g., more or less than 20 segmented flash-fill operations) concerning the number of segmented flash-fill operations on regular blocks that occur before a new segmented flash-fill operation on a different spare block is executed. Under such circumstances, the controller may adjust the margin in order to prevent triggering an erase operation before a block is fully flash-filled. In some embodiments, in addition to or as an alternative to the number of writes, the cycling rate of spare blocks and regular blocks is based on time (e.g., regular blocks and spare blocks are cycled after reaching a pre-determined time threshold). In some embodiments, the time threshold for the cycling of the spare blocks and regular blocks is between about 100 milliseconds (ms) to about 1 second(s), such as 100 ms.

Segmented spare block cycling operation 300 begins at operation 302, where the storage device engages in a write workload on a current block. At operation 304, the controller executes an erase operation on a next segment of a next block (e.g., Block X in FIG. 3) on a die (e.g., Die A). At operation 306, the controller determines whether a parameter (e.g., a time after the executing of the erase operation on the current block or a number of writes to the block) has elapsed over a first threshold (TH1). If the parameter has elapsed over TH1, then at operation 308, the controller executes an erase operation on a next segment of a first spare block (Z1) on Die A before proceeding to operation 310. If the parameter has not elapsed over TH1, then at operation 310, the controller determines whether a second parameter (e.g., a second time after the executing of the erase operation on the current block or a number of writes to the block) has elapsed over a second threshold (TH2). If the second parameter has elapsed over TH2, then at operation 312, the controller executes a write operation (e.g., a flash-fill operation) on the next segment of a second spare block (Z2) on Die A before proceeding to operation 314. At operation 314, the controller executes write operation (e.g., a flash-fill operation) on a next segment of a current block (e.g. Block Y in FIG. 3) on Die A before returning to operation 304.

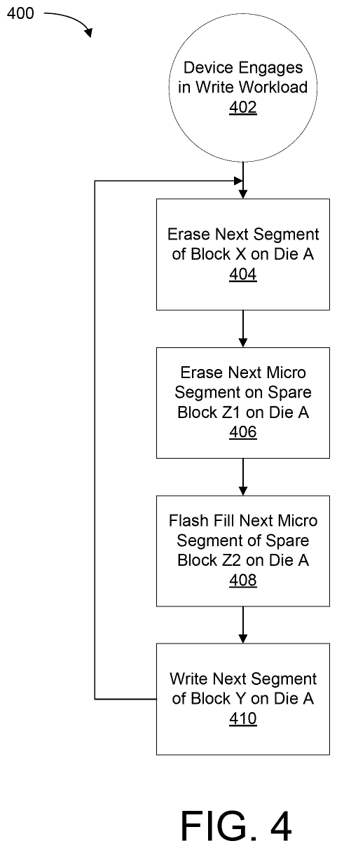

FIG. 4 is a flowchart illustration of a micro-segmented spare block cycling operation 400, according to some embodiments. In micro-segmented spare block cycling operation 400, the segments of the spare block cycling operation are broken down further into smaller atomic operations (e.g., to the minimum 1 wordline per erase/write) so that the impact to the performance of the storage device is minimal, and to avoid performance bubbles in the system. In some embodiments, the minimum number of wordlines erased/written depends on the physical properties of the segmented erase operations. For example, since the number of erase/write spare block operations would not be evenly divided between the host erase/write operations, a controller (e.g., controller 108 of FIG. 1) would be expected to balance the number of host operations versus the spare block operations. This balance further depends on the number of spare blocks per die, which will vary.

Micro-segmented spare block cycling operation 400 begins at operation 402, where the device engages in a write workload. At operation 404, the controller executes an erase operation on a next segment of a next block on a die (e.g., Die A of FIG. 4). At operation 406, the controller executes an erase operation on a next micro-segment of a first spare block on Die A. At operation 408, the controller executes a write operation (e.g., a flash-fill operation) on a next micro-segment of a second spare block on Die A. At operation 410, the controller executes a write operation (e.g., a flash-fill operation) on a next segment of a current block on Die A, before returning to operation 404.

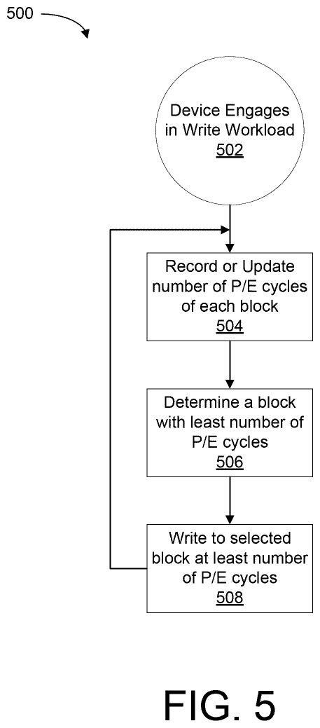

FIG. 5 is a flowchart illustration of a cycling operation 500, according to one embodiment. The operations of erasure of segments or micro-segments and the flash fill commands may be transferred from the controller (e.g., controller 108 of FIG. 1) to the CBA (i.e., a programmable die based logic). The firmware will define a few parameters per die that indicate the frequency of spare block segment cycling, depending on the number of spare blocks per die. The commands are then passed from the controller to the CBA, so that no additional overhead is required to execute the corresponding commands.

In memory systems where there is no requirement for the number of cycles between the blocks in different dies of the jumbo-block to be equal (e.g., enterprise level systems), the spare blocks may be included in the general block pool and the user data may be written to these spare blocks after each erase cycle. For example, if the entire storage device is expected to be rewritten several times per day then there is no need to relocate cold blocks since all blocks are hot. In these circumstances, the controller may keep a list of the program/erase (P/E) cycle per block and then pick the next block to write to, based on which block has the least number of P/E cycles from the list. In some embodiments, the system may detect a change in workload (e.g., there is a need to relocate cold blocks) and implement a better suited cycling operations (e.g., operations 200, 300, or 400 of FIGS. 2, 3 and 4).

Cycling operation 500 starts at operation 502, where the storage device engages in a write workload. At operation 504, the controller records or updates a list with the number of P/E cycles of each block. At operation 506, the controller selects the block with the least number of P/E cycles. At operation 508, the controller executes a write operation on the selected block with the least number of P/E cycles.

An imbalance of wear of blocks in a flash die will negatively affect the memory health of a storage device, including decreased device performance. Specifically, when spare blocks of the device remain at zero Program Erase Cycles (PECs) while, during typical device operation, regular blocks in the flash die are cycled. Cycling spare blocks and regular blocks of the device at the same rate reduces these adverse effects on device memory health. By calculating the rate of spare block updates (i.e., frequency of flash fill operations and subsequent erasure of the spare blocks) and executing periodic segmented flash fill operations and erase operations on the spare blocks during the corresponding operations to the regular blocks, the wear of blocks is “leveled” and an imbalance is avoided.

In one embodiment, a data storage device includes a memory device; and a controller coupled to the memory device, wherein the controller is configured to: engage in a write workload on a first block of a plurality of blocks; execute an erase operation on a segment of a second block of a plurality of blocks; execute a write operation on a segment of the first block, wherein the second block is the next block to engage in a write workload; determine whether a first parameter has elapsed a threshold; and execute an erase operation on a segment of a first spare block of a plurality of spare blocks if the first parameter has elapsed the threshold.

The plurality of blocks are located on a same die. The controller is further configured to interleave the executing of the erase operation with the executing of the write operation. The threshold is between 100 millisecond and 1 second. The controller is further configured to determine whether a second parameter has elapsed a second threshold; and execute a write operation on a segment of a second spare block of the plurality of spare blocks if the second parameter has elapsed the second threshold. The first parameter is a first time after the executing of the erase operation on the segment of the second block, and the second parameter is a second time after the executing of the erase operation on the segment of the second block. The first and second parameters are a number of write operations executed on the block. The write operations are flash-fill operations. The spare blocks are located on a same die as the first and second blocks. The controller is further configured to calculate a cycling rate of the plurality of blocks and the plurality of spare blocks, wherein the cycling rate is a frequency of write operations and subsequent erase operations of the respective blocks. The cycling rate of the plurality of blocks and the plurality of spare blocks are equal.

In another embodiment, a data storage device includes a memory device; and a controller coupled to the memory device, wherein the controller is configured to split each block of a plurality of blocks on a die into a plurality of segments, wherein the plurality of blocks comprise at least one regular block and at least one spare block; execute an update operation on a segment of the plurality of segments of the at least one regular block; and execute an update operation on a segment of the plurality of segments of the at least one spare block.

The update operation comprises a write operation or erase operation, and wherein the write operation is a flash-fill operation. The controller is further configured to execute an update operation on a next segment of the plurality of segments of a second regular block of the plurality of blocks; and execute an update operation on a next segment of the plurality of segments of a second spare block of the plurality of blocks, wherein rates of executing update operations on segments of regular blocks and segments of spare blocks are equal. Splitting each block into the plurality of segments further comprises splitting the plurality of segments into a plurality of micro-segments. The controller is further configured to execute an update operation on a micro-segment of the plurality of micro-segments of the at least one regular block; and execute an update operation on a micro-segment of the plurality of micro-segments of the at least one spare block. The controller is further configured to execute an update operation on a next micro-segment of the plurality of micro-segments of a second regular block of the plurality of blocks; and execute an update operation on a next micro-segment of the plurality of micro-segments of a second spare block of the plurality of blocks, wherein rates of executing update operations on micro-segments of regular blocks and segments of spare blocks are equal. The update operation comprises a flash-fill operation or erase operation.

In yet another embodiment, a data storage device includes means to store data; and a controller coupled to the means to store data, wherein the controller is configured to engage in a write workload on a plurality of blocks; record a number of program/erase (P/E) cycles for each block of the plurality of blocks; determine a block with the least number of P/E cycles; and write to the block with the least number of P/E cycles.

The controller is further configured to update the number of program/erase (P/E) cycles for each block of the plurality of blocks.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
engage in a write workload on a first block of a plurality of blocks;
execute an erase operation on a segment of a second block of a plurality of blocks;
execute a write operation on a segment of the first block, wherein the second block is the next block to engage in a write workload;
determine whether a first parameter has elapsed a threshold; and
execute an erase operation on a segment of a first spare block of a plurality of spare blocks if the first parameter has elapsed the threshold.

2. The data storage device of claim 1, wherein the plurality of blocks are located on a same die.

3. The data storage device of claim 1, wherein the controller is further configured to interleave the executing of the erase operation with the executing of the write operation.

4. The data storage device of claim 1, wherein the threshold is between 100 milliseconds and 1 second.

5. The data storage device of claim 1, wherein the controller is further configured to:
determine whether a second parameter has elapsed a second threshold; and
execute a write operation on a segment of a second spare block of the plurality of spare blocks if the second parameter has elapsed the second threshold.

6. The data storage device of claim 5, wherein the first parameter is a first time after the executing of the erase operation on the segment of the second block, and the second parameter is a second time after the executing of the erase operation on the segment of the second block.

7. The data storage device of claim 5, wherein the first and second parameters are a number of write operations executed on the block.

8. The data storage device of claim 5, wherein the write operations are flash-fill operations.

9. The data storage device of claim 5, wherein the spare blocks are located on a same die as the first and second blocks.

10. The data storage device of claim 5, wherein the controller is further configured to calculate a cycling rate of the plurality of blocks and the plurality of spare blocks, wherein the cycling rate is a frequency of write operations and subsequent erase operations of the respective blocks.

11. The data storage device of claim 10, wherein the cycling rate of the plurality of blocks and the plurality of spare blocks are equal.

12. A data storage device, comprising:
a memory device; and
a controller coupled to the memory device, wherein the controller is configured to:
split each block of a plurality of blocks on a die into a plurality of segments, wherein the plurality of blocks comprise at least one regular block and at least one spare block;
execute an update operation on a segment of the plurality of segments of the at least one regular block; and
execute an update operation on a segment of the plurality of segments of the at least one spare block.

13. The data storage device of claim 12, wherein the update operation comprises a write operation or erase operation, and wherein the write operation is a flash-fill operation.

14. The data storage device of claim 13, wherein the controller is further configured to:
execute an update operation on a next segment of the plurality of segments of a second regular block of the plurality of blocks; and
execute an update operation on a next segment of the plurality of segments of a second spare block of the plurality of blocks, wherein rates of executing update operations on segments of regular blocks and segments of spare blocks are equal.

15. The data storage device of claim 13, wherein splitting each block into the plurality of segments further comprises splitting the plurality of segments into a plurality of micro-segments.

16. The data storage device of claim 15, wherein the controller is further configured to:
execute an update operation on a micro-segment of the plurality of micro-segments of the at least one regular block; and
execute an update operation on a micro-segment of the plurality of micro-segments of the at least one spare block.

17. The data storage device of claim 16, wherein the controller is further configured to:
execute an update operation on a next micro-segment of the plurality of micro-segments of a second regular block of the plurality of blocks; and
execute an update operation on a next micro-segment of the plurality of micro-segments of a second spare block of the plurality of blocks, wherein rates of executing update operations on micro-segments of regular blocks and segments of spare blocks are equal.

18. The data storage device of claim 17, wherein the update operation comprises a flash-fill operation or erase operation.

19. A data storage device, comprising:
means to store data; and
a controller coupled to the means to store data, wherein the controller is configured to:
engage in a write workload on a plurality of blocks;
record a number of program/erase (P/E) cycles for each block of the plurality of blocks;
determine a block with the least number of P/E cycles; and
write to the block with the least number of P/E cycles.

20. The data storage device of claim 19, wherein the controller is further configured to update the number of program/erase (P/E) cycles for each block of the plurality of blocks.
